(19) United States
(12) Patent Application Publication
(10) Pub. No.: US 2007/0245563 A1
(43) Pub. Date: Oct. 25, 2007

(54) Extractor

(76) Inventor: John A. Smith, Essex (GB)

Correspondence Address: DICKSTEIN SHAPIRO LLP, 1825 EYE STREET NW, Washington, DC, 20006-5403, US

(21) Appl. No.: 11/785,885

(22) Filed: Apr. 20, 2007

(30) Foreign Application Priority Data
Apr. 21, 2006 (GB) 0607933.9

(51) Int. Cl. B23P 17/00

(52) U.S. Cl. 29/898.08; 29/426.1; 29/252

(57) ABSTRACT

A bearing extractor including a probe having an inlet bore at one end for pressurised hydraulic fluid, an outlet for the pressurised hydraulic fluid in an outer circumference of the probe, and a seal on each side of the outlet for forming a seal between the probe outer circumference and a surrounding bearing surface. Pressurised hydraulic fluid is fed through bore to outlet. The fluid fills the gap between the bearing ends and forces the bearings apart, to urge at least one of them from the housing. Greater radial force is applied to one bearing by positioning the respective seal further from the gap, and that bearing is preferentially held in the housing, the other bearing being urged from the housing and carrying the extractor with it.

### INTRODUCTION AND BACKGROUND

The present invention relates to a bearing extractor. The invention is particularly concerned with an extractor for extracting bearings from aircraft undercarriage and flying control assemblies, but it has wider applicability.

With aircraft assemblies it is a particular challenge to minimise damage to the bearing housing when extracting the bearing. Also, when extracting a bearing for inspection purposes it is desirable to avoid damage to the bearing so that the bearing can be re-used.

My applications GB-A-2370527 and GB-A-2401572 show examples of bearing extractors. A difficulty with these and other prior art extractors is that it is difficult to deal with bearings of small size because of the need to couple the extractor head, which bears on an end of the bearing, to the puller device which pulls the extractor head and bearing from the bearing housing.

### SUMMARY OF THE INVENTION

A first aspect of my invention provides an extractor in which hydraulic pressure is brought to bear directly on an end of a bearing to urge the bearing from its housing. The invention is particularly suitable for use when a bearing is fitted in a blind bore or two bearings are mounted end to end in a housing, the hydraulic fluid being fed between the bearing ends to urge the bearings apart.

Another aspect of my invention provides a bearing extractor comprising a probe having an inlet at one end for pressurised hydraulic fluid, an outlet for the pressurised hydraulic fluid in an outer circumference of the probe, and a seal on each side of the outlet for forming a seal between the probe outer circumference and a surrounding surface. The seal prevents substantial leakage of hydraulic fluid past the seals so that the intervening space can be pressurised with the hydraulic fluid. The probe is positioned with the seals sealing against respective surfaces, at least one being a surface of a removable bearing. Hydraulic fluid is pumped into the region between the seals and so will cause the bearing to move. The seals are preferably arranged to increase their sealing efficiency under the pressure from the hydraulic fluid. The invention is particularly useful when bearings are mounted end to end with a space between them. The hydraulic fluid is pumped into the space between the bearing ends and so pushes the bearings apart, forcing at least one of them out of the housing.

The invention also provides a bearing extractor for extracting a bearing form a blind bore, in which a probe has an inlet for pressurised hydraulic fluid, an outlet distal of the inlet and a seal around the circumference of the probe for sealing against the bearing inner surface.

Other aspects and preferred features of the invention will be apparent from the following description and the accompanying claims.

### BRIEF DESCRIPTION OF THE DRAWINGS

The invention will be further described with reference to the accompanying drawings, in which

FIG. 1 is an axial cross-section thorough an extractor forming an embodiment of the invention, positioned in two bearings prior to extraction of a bearing;

FIG. 2 is a perspective view of a probe of the extractor of FIG. 1;

FIG. 3 is an axial cross-section corresponding to FIG. 1, with a bearing partially extracted;

FIG. 4 illustrates a further embodiment of the invention, and

FIG. 5 illustrates schematically the extraction of a bearing from a blind bore.

### DESCRIPTION OF THE PREFERRED EMBODIMENTS

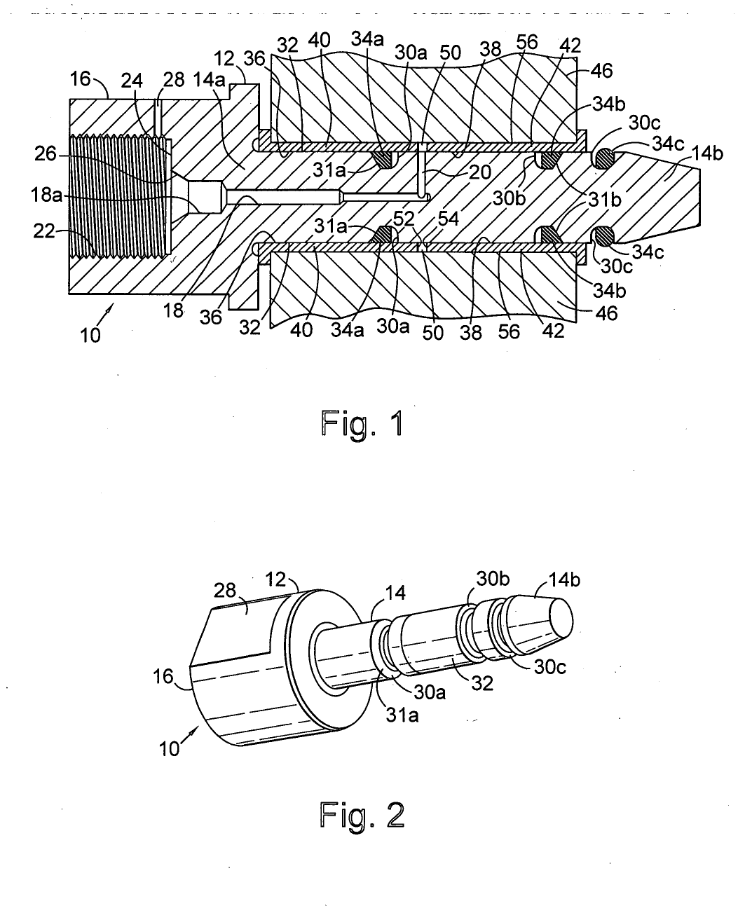

Referring to FIG. 1, an extractor 10 of the present invention comprises a probe 12 having an elongate body 14 and collar 16 at one end 14a of the body 14 for coupling the probe 12 to a pressurised hydraulic fluid supply (not shown).

The probe 12 has an axial bore 18 extending from an inlet end 18a to mid way along the length of the probe body 14 where it fluidly connects with a radial bore 20 forming a hydraulic fluid outlet.

The collar 16 has a threaded recess 22 for receiving an end of a pressurised hydraulic fluid supply line (not shown). The base 24 of the recess 22 has a conical face 26 to form a seal with the fluid supply line and defines an entrance to the axial bore 18.

A radial passageway 28 extends from the recess 22 to the collar 16 and provides a means for pressure relief during the coupling of the collar 16 to the hydraulic fluid supply line.

The collar 16 is preferably integrally formed with the elongate probe body 14. The collar 16 may be provided with a partially threaded through bore for receiving a threaded end portion of the probe 14.

The elongate probe body 14 is of circular cross-section. Seals are formed by circumferential sealing rings 34a, 34b, 34c positioned in respective circumferential grooves 30a, 30b, 30c in the outer peripheral surface 32 of the body 14.

The grooves 30a, 30b, 30c are generally U-shaped in cross section. The cross-section tailored to the particular sealing elements 34a, 34b, 34c to form a seal between the probe body 14 and the surrounding bearing surfaces 36, 38 when pressure is applied in the axial direction by urging hydraulic fluid through radial bore 20, as will be described hereinafter. The grooves 30a, 30b have a sloping surface 31a, 31b, on the unpressurised side of the sealing element 34a, 34b to form a tapered housing, encouraging the seal to migrate outwards under pressure and increasing the sealing efficiency under the high pressures which are to be applied. Preferably, the sealing elements may be of the elastomeric O-ring type with a well-defined hardness/extensibility, though they are not limited thereto. One such type of sealing element is marketed as an O-ring by James Walker Group.

The diameter of bore 18 is stepped along its length, reducing in diameter as it reaches the radial bore 20. If the diameter of bore 18 is too large compared to the overall diameter of probe body 14, the body 14 may be weakened and liable to fracture in use.

As seen in FIG. 1, the probe 12 is dimensioned to allow a snug fit within bearings 40, 42 which are held in a bearing housing 46 which may be, for example, part of an aircraft undercarriage assembly. Preferably the clearance between the outer circumferential surface 44 of the probe body 14 and the inner surfaces 36, 38 is about 0.002 to 0.005 inches and preferably about 0.004 inches. The clearance should be small enough to prevent creep of the sealing element 34 under the pressure of the hydraulic fluid but large enough to allow the hydraulic fluid to penetrate between the probe surface 44 and the bearings 40, 42 in the region between the sealing elements 34a, 34b. Bearings 40, 42 are positioned in housing 46 with a gap 50 between their end surfaces 52, 54, as is typical in the art.

In use, the probe body 14 is fed into bearings 40,42 so that a respective sealing element 34a, 34b mates against a respective bearing inner surface 36, 38. Hydraulic fluid is fed under pressure though bore 18 and radial bore 20 into the region of the gap 50. The pressurised fluid acts on the end surfaces 52, 54 of the bearings 40,42 and when a sufficiently high pressure is reached the bearings are urged apart, thus forcing one of the bearings from the housing 46. A pressure up to 40,000 p.s.i. has been found sufficient to achieve movement of most bearings from their housing.

Because there is clearance between the probe outer surface and the bearing, the radial bore 20 need not align with the gap 50 when the probe is inserted into the bearings 40, 42—hydraulic fluid will pass between the probe and bearing to reach and fill the gap 50. However, it is preferable that the bore 20 align with or be close to the gap 50.

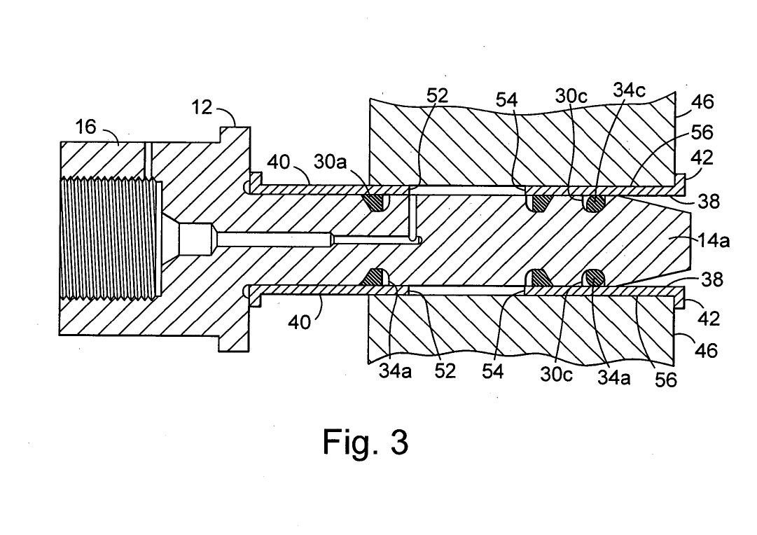

We have found that it is particularly advantageous to position the sealing elements 34a, 34b asymmetrically with respect to the gap 50 between the bearings 40, 42. As seen in FIG. 1, sealing element 34a is closer to the gap 50 than sealing element 34b. The effect of this is that a higher total force is applied in the radial direction to bearing 42. This appears to expand the bearing sufficiently to increase the grip of the bearing 42 on the housing wall 56, and so the other bearing 40 will tend to be moved preferentially out of the housing 46. Referring to FIG. 3, as bearing 42 moves out of the housing 46, i.e. to the left in FIG. 1, it will abut collar 16 and so carry the probe 12 with it. In turn, sealing element 34b will move along the bearing 42. The sealing element 34b will leave the bearing 42 before bearing 40 has been completely removed from the housing 46. Thus, we provide a third sealing element 34c, at the outer end 14b of the probe body 14 to seal against the bearing 42.

The outer end 14b of the probe 14 is tapered to facilitate mounting of the sealing elements.

Where there is a large clearance between the probe body 14 and the surrounding bearings 40, 42, for example due to high wear or oval or damaged bores, it may be helpful to provide a backing ring in the O-ring grooves 34a, 34b. The backing rings expand radially outwards under the pressure of the hydraulic fluid to provide support in the axial direction for the sealing elements.

The extractor of this invention is particularly useful with bearings of internal diameter up to about 1.75 inches.

Once one bearing of a pair has been extracted with the extractor of this invention, the other bearing can be readily removed by applying a mechanical force to the exposed bearing end surface.

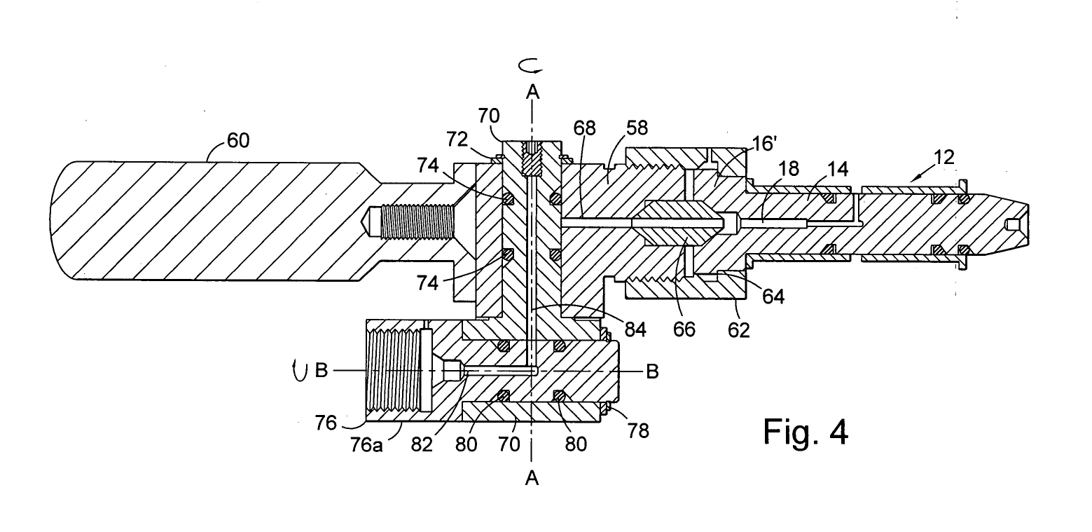

Referring to FIG. 4, this shows a rotatable coupling for a hydraulic fluid supply. The probe body 14 has an integral end collar 16′ and is similar to the probe of FIGS. 1 to 3. The probe 12 is coupled to a spigot 58 on a handle by a cap 62 which is threadedly attached to the spigot 58 and bears on a shoulder 64 of the collar 16′. A bullet 66 fluidly connects the hydraulic fluid passage 18 of the probe with a hydraulic fluid path 68 though the handle 60. A T-piece 70 is rotatably mounted in the handle 60 to rotate about an axis A-A and is held in place by a circlip 72. O-rings 74 form a seal with the handle 60. A stem 76 is in turn rotatably mounted in the T-piece 70 to rotate about axis B-B and be coupled to a hydraulic fluid supply as at inlet 76a. Stem 76 is held in place by a circlip 78 and O-rings 80 form a seal with the T-piece 70. Bores 82, 84 in the stem and the T piece provide a fluid connection with fluid path 68 thorough to the probe 12.

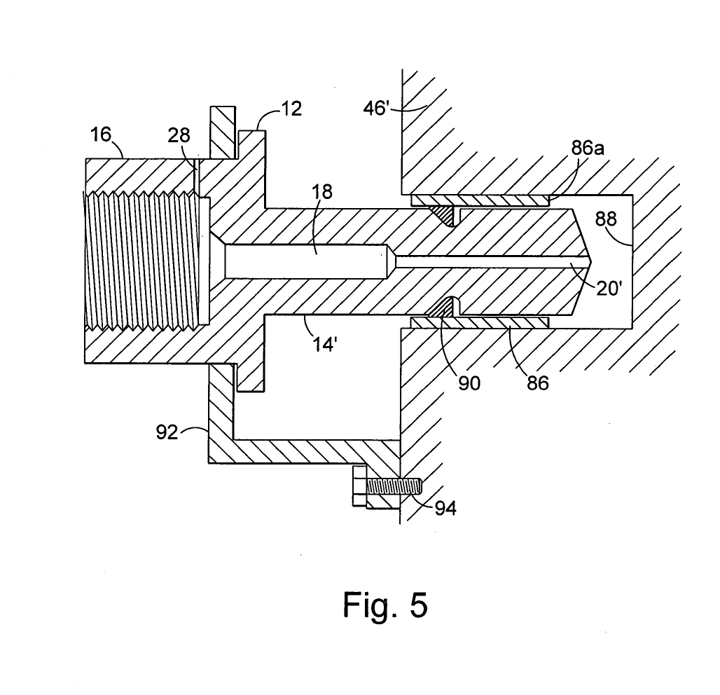

Referring to FIG. 5, the method and apparatus of this invention may also be used to extract a bearing 86 from a blind bore 88 in a housing 46′. A probe body 14′ is inserted in the bore 88 with an outlet 20′ for hydraulic fluid inward of a sealing element 90 which forms a seal with between the probe body 14′ and the bearing 86. The probe 12′ is clamped to the housing 46′ by a strap 92 and screw 94 with enough clearance between the collar 16 and the housing 46′ for the bearing 86 to leave the housing 46′, and hydraulic fluid is pumped through the probe hydraulic passage, bore 18. The O-ring sealing element 90 prevents escape of the hydraulic fluid and so the interior of the bore 88 is pressurised and the fluid acts on the distal end 86a of the bearing to urge it out of the housing, past the sealing element 90.

Various modifications will be apparent to those in the art and the scope of the invention described and claimed herein is not be limited to the details of the specific embodiments which have been described by way of example only.

What is claimed is:

1. A bearing extractor comprising a probe having an inlet at one end for pressurised hydraulic fluid, an outlet for the pressurised hydraulic fluid in an outer circumference of the probe, and a seal on each side of the outlet for forming a seal between the probe outer circumference and a surrounding surface.

2. A bearing extractor as claimed in claim 1, in which the seals are positioned at different distances from the outlet.

3. A bearing extractor as claimed in claim 2, in which the seal between the inlet and outlet is closer to the outlet than the other seal.

4. A bearing extractor as claimed in claim 2, in which a third seal is provided.

5. A bearing as claimed in claim 4, in which the third seal is provided outward of the seal which is further from the outlet.

6. A bearing as claimed in claim 5, in which the third seal is provided at the other end of the probe to the inlet.

7. A method of extracting a bearing from a housing, the bearing having an axial end, the method comprising inserting within the housing a probe having an outlet for hydraulic fluid, providing a first seal between the probe and an inner surface of the bearing on one side of the outlet and the bearing end, and a second seal between the probe and the housing on the other side of the outlet, and feeding pressurised hydraulic fluid into the region between the first and second seals.

8. A method of extracting a bearing from a housing having first and second bearings positioned therein with a gap between adjacent axial ends of the bearings, the method comprising inserting within the housing a probe having partway along its length an outlet for hydraulic fluid, providing a first seal between the probe and an inner surface of the first bearing on one side of the outlet and the gap, and a second seal between the probe and the second bearing on the other side of the outlet and the gap, and feeding pressurised hydraulic fluid into the region between the first and second seals.

9. A method as claimed in claim 8, in which the seals are at different distances from the gap.

10. A method as claimed in claim 9, in which the seal between an inlet on the probe for the hydraulic fluid and the gap is closer to the gap than the other seal.

11. A method as claimed in claim 10, in which a third seal is provided.

12. A method as claimed in claim 11, in which the third seal is provided outward of the seal which is further from the gap.

13. A method as claimed in claim 12, in which the third seal is provided at the other end of the probe to the inlet.

14. A method of extracting a bearing from a housing, in which hydraulic pressure is bought to bear directly on an end of the bearing to urge the bearing from its housing.

15. A method as claimed in claim 14, in which two bearings are mounted end to end in a housing, and pressurised hydraulic fluid is fed between the bearing ends to urge the bearings apart.

16. In combination, a bearing housing having two bearings arranged therein with a gap between facing axial end walls of the bearings, and a bearing extractor comprising a probe having an inlet at one end for pressurised hydraulic fluid, an outlet for the pressurised hydraulic fluid in an outer circumference of the probe, and a seal on each side of the outlet for forming a seal between the probe outer circumference and a surrounding bearing surface when the probe is inserted into the bearings, each seal forming, in use of the extractor, a seal with a respective one of the bearings.

17. The combination of claim 16, wherein there is a clearance of up to about 0.005 inches between the outer circumferential surface of the probe and the bearing surfaces.

18. The combination of claim 17, wherein the clearance is between about 0.002 and 0.004 inches.

19. The combination of claim 17, wherein, in use, the probe and seals are positioned so that one of the bearings is subjected to a greater radial force from the hydraulic fluid that the other bearing so that the one bearing is more likely to be moved in the housing than the other bearing.

20. The combination of claim 18, wherein, in use, the probe and seals are positioned so that one of the bearings is subjected to a greater radial force from the hydraulic fluid that the other bearing so that the one bearing is more likely to be moved in the housing than the other bearing.

21. A bearing extractor comprising a probe having an inlet at one end for pressurised hydraulic fluid, a seal on an outer circumferential surface of the probe forming a seal between the probe outer circumference and a surrounding surface, and an outlet beyond the seal, relative to the inlet, for the pressurised hydraulic fluid.

22. A method of extracting a bearing from a blind housing, the bearing having an axial end, the method comprising inserting into the open end of the housing a probe having an outlet for hydraulic fluid, providing a first seal between the probe and an inner surface of the bearing at a position between the outlet and the housing open end, and feeding pressurised hydraulic fluid into the housing.

23. In combination, a housing having a blind bore with a bearing arranged therein with a gap between an inner end of the bearing and the bottom of the housing bore, and a bearing extractor comprising a probe having an inlet at one end for pressurised hydraulic fluid, an outlet for the pressurised hydraulic fluid, and a seal between the inlet and outlet for forming a seal between the probe outer circumference and a surrounding bearing surface when the probe is inserted into the bearing.
